(19) United States
(12) Patent Application Publication
(10) Pub. No.: US 2005/0047708 A1
(43) Pub. Date: Mar. 3, 2005

(54) Optical interconnect and method for making the same

(76) Inventors: Kelvin Ma, Clifton Park, NY (US); Todd R. Tolliver, Clifton Park, NY (US); John J. Soderberg, Sequim, WA (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/648,717

(22) Filed: Aug. 26, 2003

(51) Int. Cl. G02B 6/12; G02B 6/26

(52) U.S. Cl. 385/14; 385/15

(57) ABSTRACT

A method of fabricating an integrated optical interconnection includes forming a first optical waveguide in a semiconductor substrate, forming a first layer of dielectric material disposed above the optical waveguide, forming an optical interconnect in the first dielectric layer and disposed proximate to the first optical waveguide. The method further includes forming a second layer of dielectric material disposed above the optical interconnect, forming a second optical waveguide in the second layer of dielectric material and disposed proximate to the first optical waveguide, and forming a conductive contact disposed above and proximate the second optical waveguide.

### TECHNICAL FIELD OF THE INVENTION

The present invention relates generally to the field of optoelectronic devices, and more particularly to an optical interconnect and a method for making the same.

### BACKGROUND OF THE INVENTION

The requirement for significant jumps in circuit clock speeds has pushed interest in optical signal transmission in integrated circuits to the forefront. Optical data transmission, first realized in the field of telecommunications, has the potential to bring the advantages of high speed, high bandwidth, electrical isolation, noise immunity and interference immunity to integrated circuits. Although optoelectronic integrated circuits hold great promise, their implementation has proven to be non-trivial. This is particularly true for the realization of vertical optical interconnects that convey the light from one integrated waveguide layer to another. There, optoelectronic integrated circuits are labor and process intensive, resulting in high manufacturing costs at low production volumes. Due to these and other reasons, current technology is restricted to single-layer integrated optical waveguides.

### SUMMARY OF THE INVENTION

In accordance with an embodiment of the present invention, a method of fabricating an integrated optical interconnect includes forming a first optical waveguide in a semiconductor substrate, forming a first layer of dielectric material disposed above the optical waveguide, forming an optical interconnect in the first dielectric layer and disposed proximate to the first optical waveguide. The method further includes forming a second layer of dielectric material disposed above the optical interconnect, forming a second optical waveguide in the second layer of dielectric material and disposed proximate to the first optical waveguide, and forming a conductive contact disposed above and proximate to the second optical waveguide. The metal contact is operable to make electrical connections between the optoelectronic components.

In accordance with another embodiment of the invention, a method of making an optical integrated circuit includes forming a first dopant region operable to function as an optical waveguide in a substrate, forming a first layer of dielectric material disposed above the first dopant region, forming a second dopant region in the first dielectric layer and disposed above and proximate to the first dopant region, where the second dopant region is operable to optically couple to the first dopant region. The method further includes forming a second layer of dielectric material disposed above the second dopant region, and forming a third dopant region in the second layer of dielectric material and disposed above and proximate to the second dopant region, where the third dopant region operable to optically couple to the second dopant region.

In accordance with yet another embodiment of the present invention, a method of making an optical integrated circuit includes forming a sacrificial layer above a substrate, forming a first dielectric layer above the sacrificial layer, forming a first dopant region operable to function as an optical waveguide in the first dielectric layer, forming a second dielectric layer disposed above the first dielectric layer, forming a second dopant region in the second dielectric layer and disposed above and proximate to the first dopant region, the second dopant region is operable to optically couple to the first dopant region. The method further includes forming a third dielectric layer disposed above the second dielectric layer, forming a third dopant region in the third dielectric layer and disposed above and proximate to the second dopant region, the third dopant region operable to optically couple to the second dopant region. The method further includes removing the sacrificial layer, forming a first conductive contact above the third dielectric layer, where the first conductive contact is operable to make optoelectronic contact with the first dopant region. The method further includes forming a second conductive contact below the first dielectric layer, where the second conductive contact is operable to make optoelectronic contact with the first dopant region.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A through 1K are cross-sectional views of an integrated circuit substrate in various stages of manufacture according to the present invention;

FIG. 2A through 2V cross-sectional views of an integrated circuit substrate in various stages of manufacture according to the present invention; and

FIGS. 3 through 6 are illustrative diagrams showing integrated optical interconnects providing reverse direction, same direction, right turn, and left turn interconnections between two waveguides disposed in different layers.

### DETAILED DESCRIPTION OF THE DRAWINGS

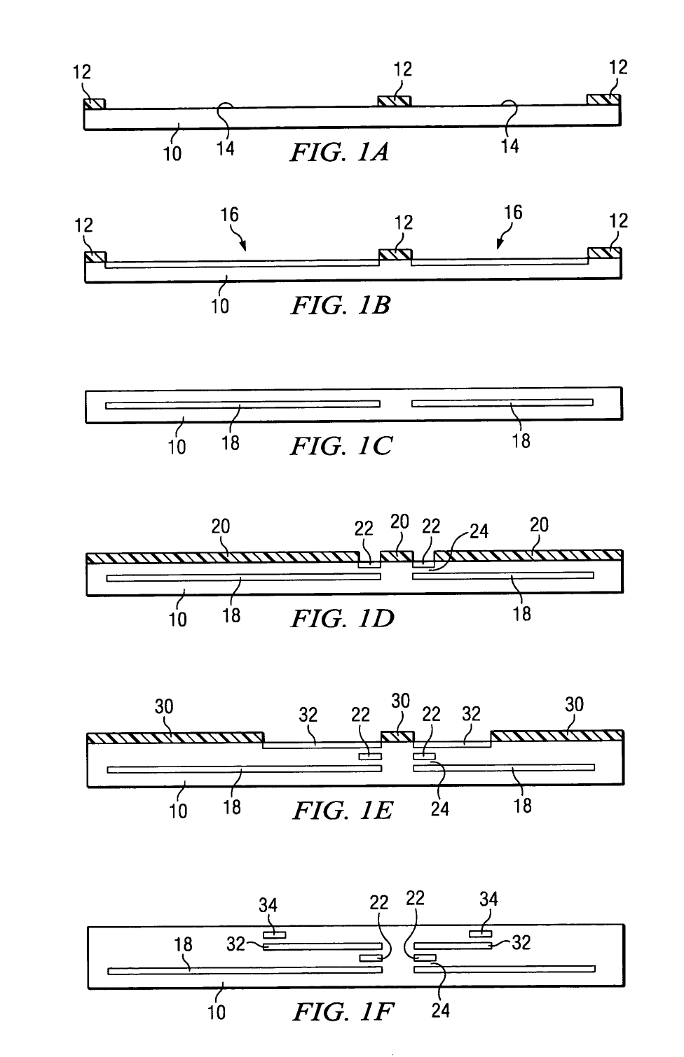

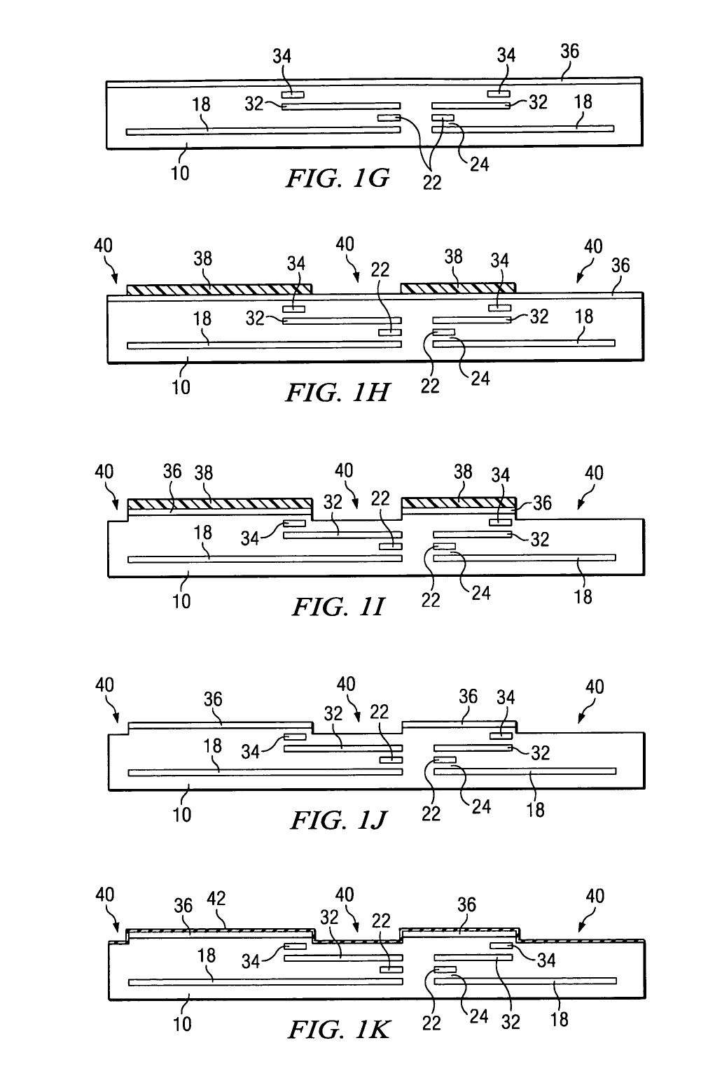

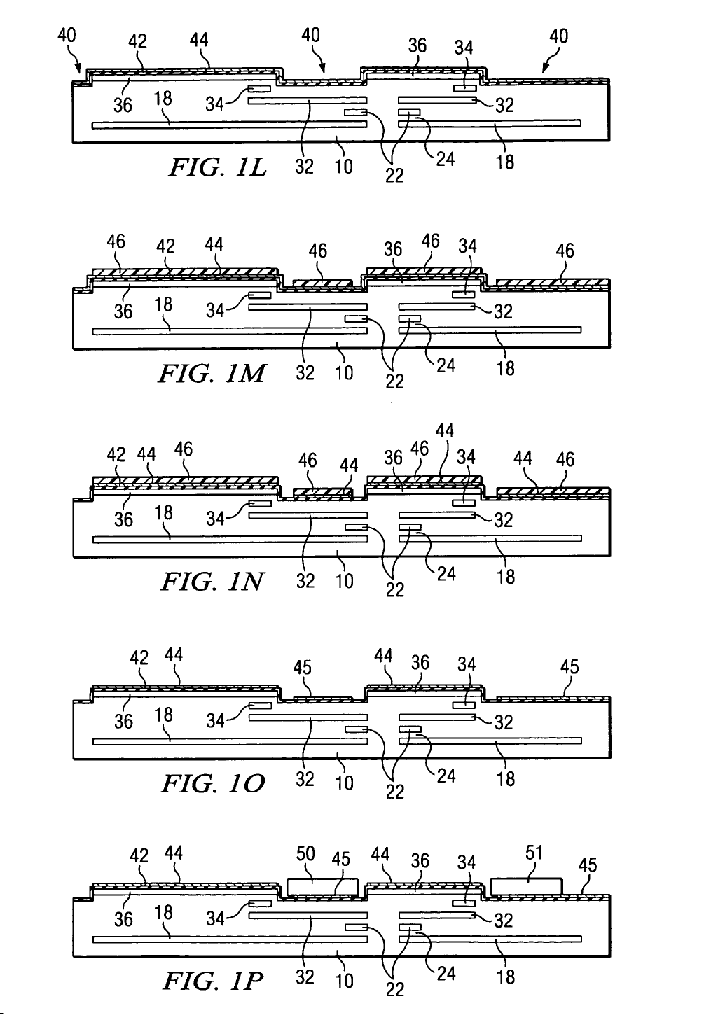

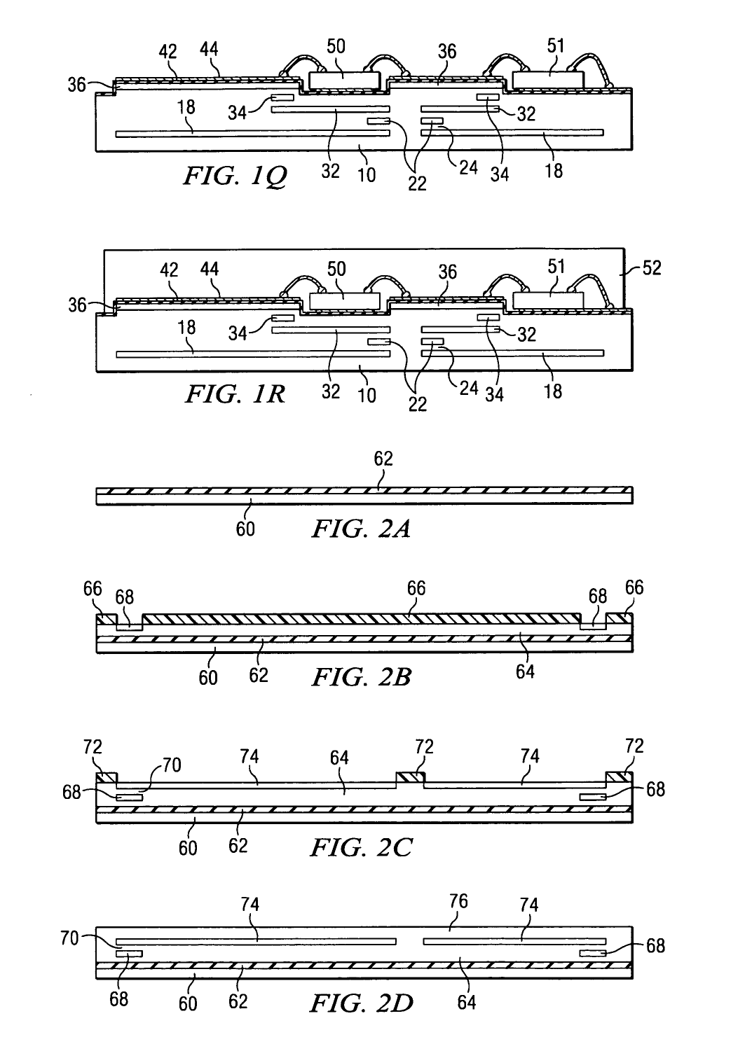

The preferred embodiment of the present invention and its advantages are best understood by referring to FIGS. 1 through 6 of the drawings, like numerals being used for like and corresponding parts of the various drawings.

FIGS. 1A through 1K are cross-sectional views of an integrated optical interconnect circuit in various stages of manufacture according to the present invention. In FIG. 1A, a substrate 10 is masked by a mask 12 that defines an optical waveguide pattern of a first layer. Substrate may be of any suitable dielectric material, such as silicon, gallium arsenide, sapphire, gallium nitride, etc. Mask 12 leaves predetermined regions 14 of the surfaces of substrate 10 exposed for ion implantation, diffusion or another suitable method, as shown in FIG. 1B. A dopant of the desired dosage and impurities is used to create dopant regions 16 in substrate 10. The amount of dopant changes the dielectric or the index of refraction between the waveguide core and cladding. The difference in the index of refraction determines the optical confinement of the waveguide. The amount of dopant required for a particular application depends on the amount of optical confinement required for the application. In FIG. 1C, mask 12 is removed and the substrate dielectric material is regrown over the entire surface, so as to cover dopant regions 16 and form a first optical waveguide layer 18. A further mask 20 is formed and used to create dopant regions 22 that operate as optical vias or interconnects (in the form of rings, disks, and other configurations). A small dielectric gap 24 is formed between the optical vias 22 and optical waveguide 18. Optical via or interconnect 22 is an optical resonator that couples energy from a first waveguide and transfers it to a second waveguide. The coupling efficiency is controlled, at least in part, by the size of the dielectric gap between the waveguide and the optical via.

In FIG. 1E, mask 20 is removed and an additional iteration of using a mask 30 and ion implantation, diffusion or another suitable process is used to create a second layer of optical waveguide 32. The process of dielectric growth, masking, doping, mask removal and regrowth continues to construct a second layer of optical via 34, as shown in FIG. 1F. This process may be repeated until the desired number of layers of optical interconnects have been made. Thereafter, anther dopant layer 36 forming an additional optical waveguide layer is created across the top surface of substrate 10, as shown in FIG. 1G. In FIG. 1H, a patterned mask is applied to cover the optical waveguides on the top surface. The mask openings 40 indicate chip pocket regions where optical, optoelectronic and electronic devices will be placed. An etching process is then used to etch through dopant layer 36, as shown in FIG. 1I. Conventional etching processes such as reactive ion etching or another suitable process may be used. Mask 38 is then removed, as shown in FIG. 1J.

A thin cladding layer 42 is then deposited across the top surface of substrate 10 using a sputtering or similar technique, as shown in FIG. 1K. Cladding layer 42 comprises a material that has a lower index of refraction than waveguide region 36 to provide optical confinement of the light signal in the waveguide and has low optical loss. Any suitable material may be used such as a polymer. A metal reflective and conductor layer 44 is then formed over cladding layer 42, as shown in FIG. 1L. Metal layer 44 has a high reflective surface and may be copper, gold, titanium or any combination of conductive materials. A process such as a sputtering process may be used to form metal layer 44. A mask 46 is used to etch metal layer 44 and define electrical contacts and lines therein, as shown in FIGS. 1M and 1N. Metal layer 44 functions to reflect scattered signal light escaping from the waveguide's cladding and direct it back into the waveguide. Mask 46 is then removed, as shown in FIG. 1O. The metal layer formed in the depressed regions or chip pocket regions is operable as metal alignment pads 45 for optical, optoelectronic and electronic components. Metal alignment pads 45 may be used for solder reflow self-alignment process for aligning the components to the waveguides. In FIGS. 1P and 1Q, optical, optoelectronic and electronic components 50 and 51 are placed at predetermined locations and coupled to the surface of substrate 10, and wire-bonded or otherwise electrically coupled to metal contacts and lines formed in layer 44. In FIG. 1R, an optional encapsulation process may be performed to encapsulate the components and the surface of the substrate with an insulating material. Conventional chip encapsulation processes may be used.

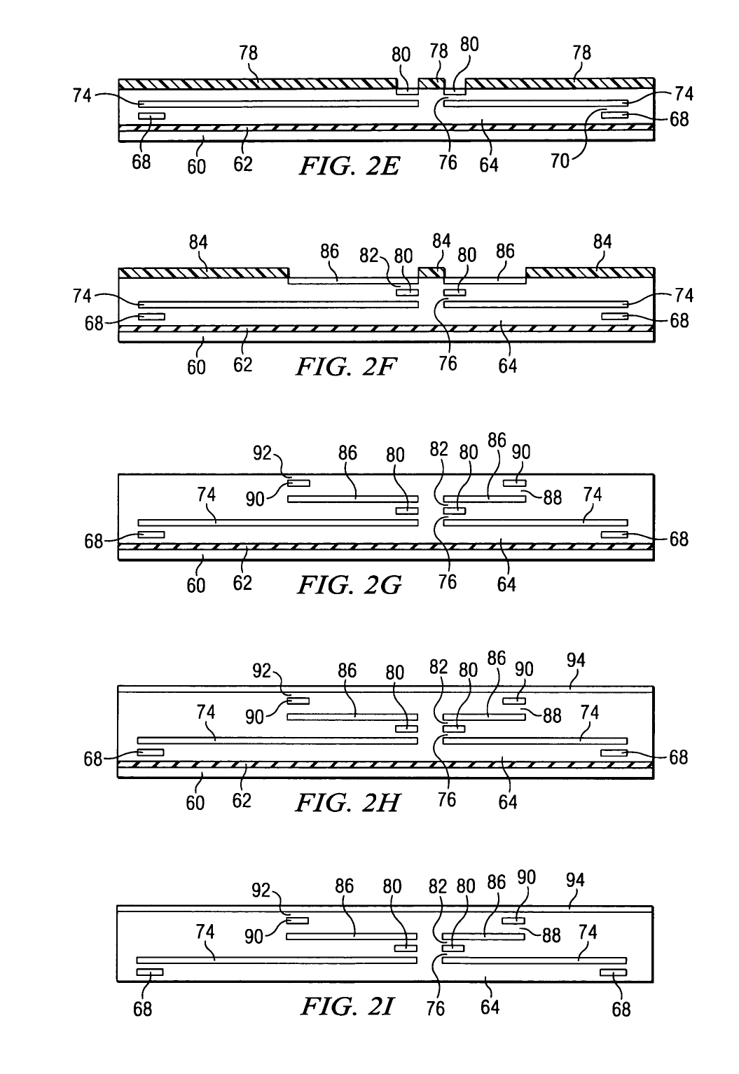

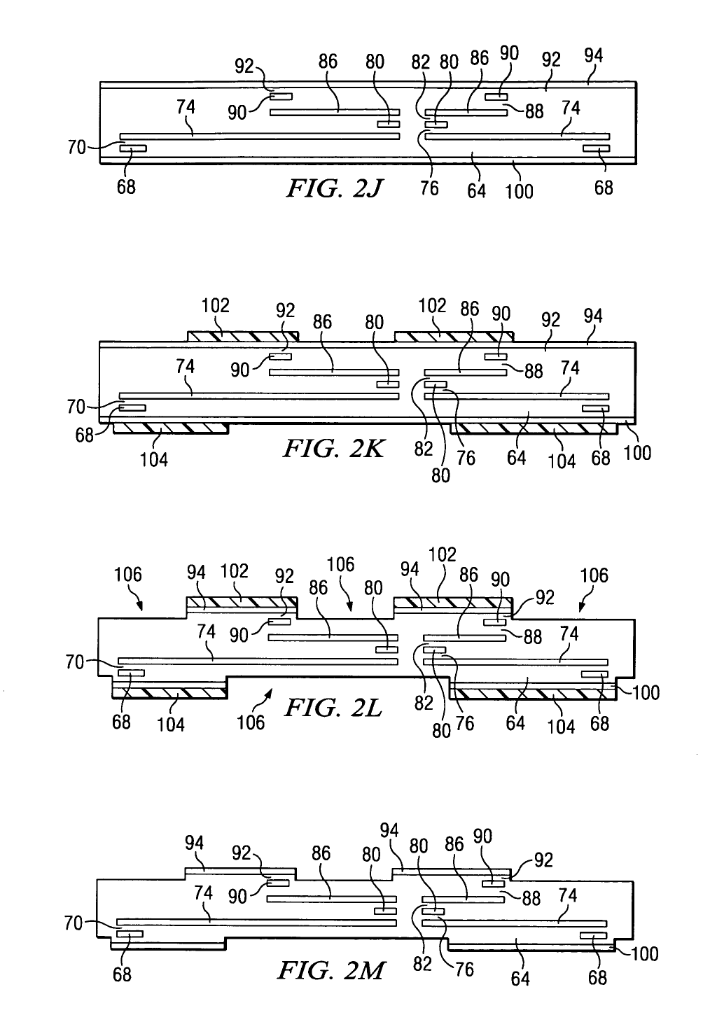

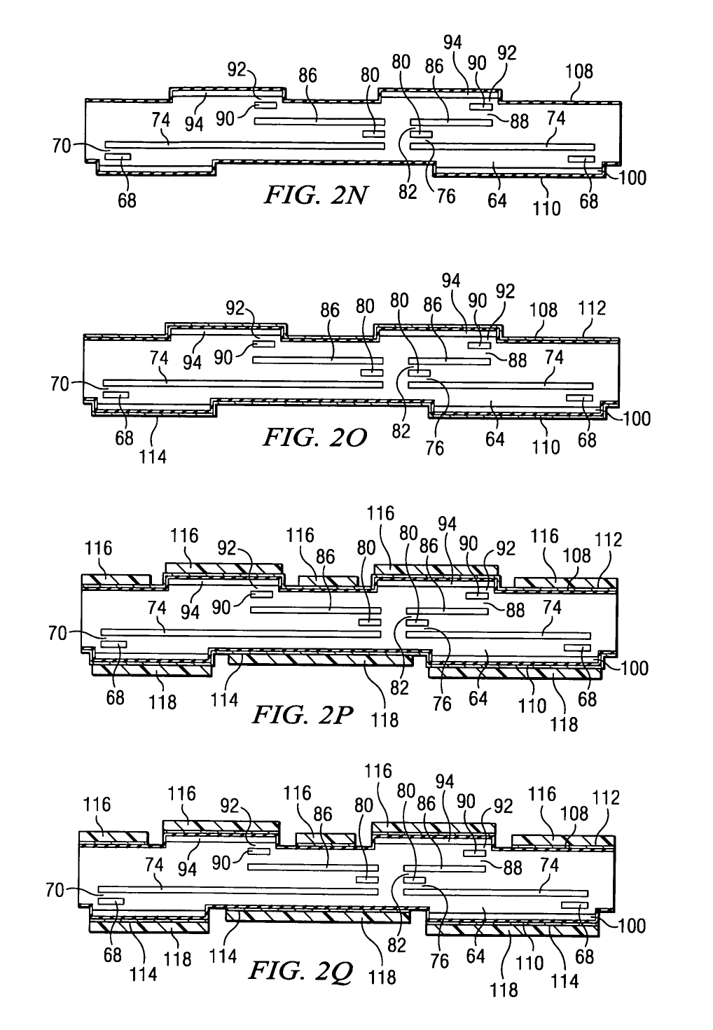

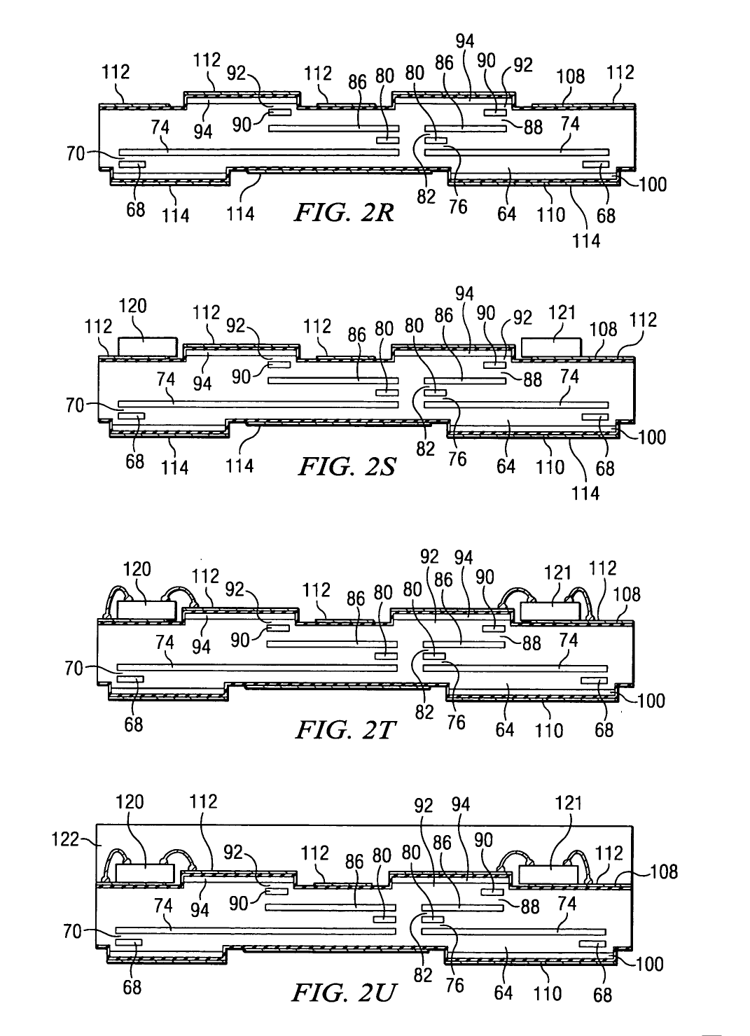

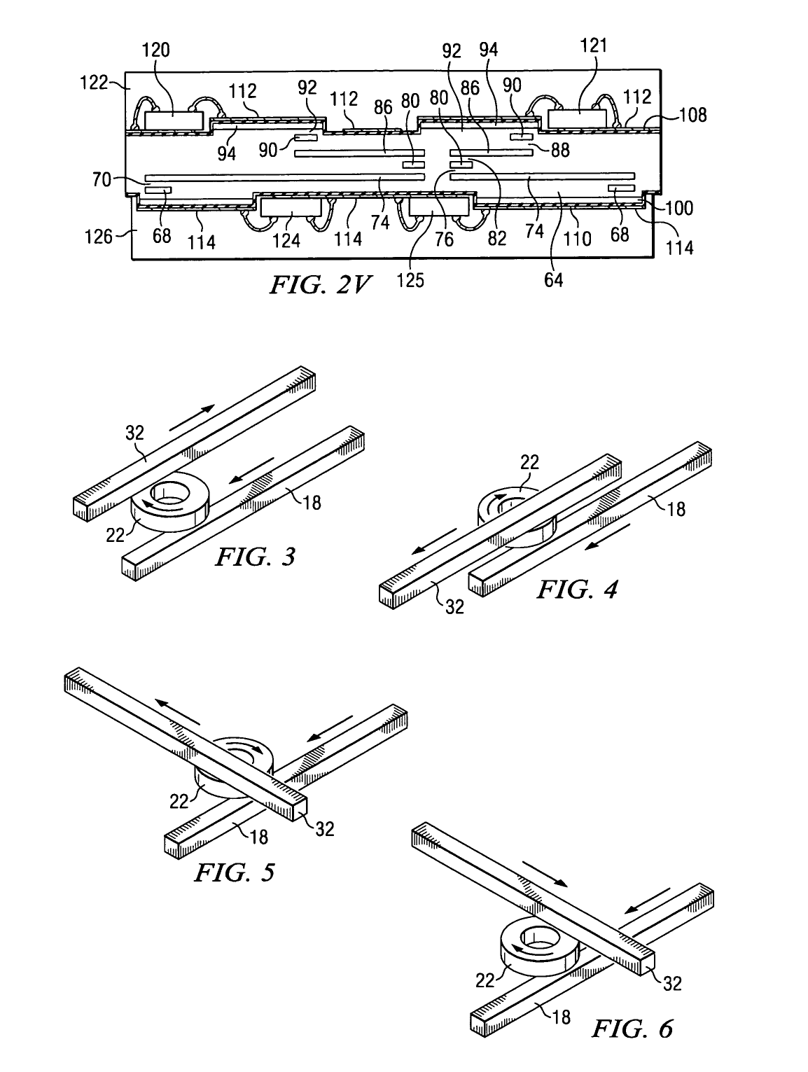

The above fabrication process forms optical waveguides and interconnects that operate with optical, optoelectronic and electronic components placed on a single side of the integrated optical interconnect circuit. FIG. 2A through 2V are cross-sectional views of a double-sided integrated optical interconnect circuit in various stages of manufacture according to the present invention. In FIG. 2A, a sacrificial oxide layer 62 is grown on top of a substrate 60. Substrate 60 may be a dielectric material such as silicon, gallium arsenide, sapphire, gallium nitride, etc. Oxide layer 62 will be the base for fabricating optical interconnect and waveguide layers on the first side of the integrated circuit, but it will be etched away and removed along with substrate layer 60 when optical structures are constructed on the second side. In FIG. 2B, further growth of substrate dielectric material 64 is added over oxide layer 62. Substrate material 64 is preferably the same as substrate layer 60 or a material with a similar index of refraction in order to maximize coupling efficiency. A mask 66 is then used to define a first level of optical interconnect 68. Unmasked regions of the substrate dielectric material surface are doped using a suitable technique such as ion implantation to form optical interconnect 68, such as ring or disk resonators, etc. to couple light vertically through the structure. After mask 66 has been removed, another layer of substrate dielectric material 70 is formed, followed by masking and then doping using mask 72 to create dopant regions 74. This doped layer 74 is the first optical waveguide layer. As shown in FIG. 2D, mask 72 is removed and another layer of substrate dielectric material 76 is grown above optical waveguide layer 74. Another patterned mask 78 is used to create another dopant layer 80 that form another layer of optical interconnects above optical waveguide layer 74, as shown in FIG. 2E. As before, mask 78 is removed and growth of an additional layer of substrate dielectric material 82 is performed. Masking using mask 84 and doping are performed to create the next waveguide layer 86, as shown in FIG. 2F. Mask 84 is then removed and the formation of additional substrate layers 88 and 92 and layers of optical interconnect 90 are performed as shown in FIGS. 2B through 2F until the desired number of layers is achieved. The top-most layer is a substrate dielectric material layer 92 above an optical interconnect layer 90. In FIG. 2H, a blanket dopant region 94 is created in substrate dielectric material layer 92.

Beginning in FIG. 21, fabrication processes are also performed on a second side of the integrated optical interconnect circuit. Substrate layer 60 and sacrificial oxide layer 62 are first removed, as shown in FIG. 21. Substrate dielectric layer 64 becomes the outermost/bottom-most layer after the removal of layers 60 and 62. Substrate dielectric layer 64 is then blanket doped to form a layer of dopant region 100, as shown in FIG. 2J. In FIG. 2K, patterned masks 102 and 104 are used to mask off predetermined areas of the first and second sides of the integrated circuit, respectively. Etching is then performed to etch through dopant regions 94 and 100 to create optical waveguides and pockets 106 for accommodating optical, optoelectronic and electrical components and devices on both sides of the integrated circuit, as shown in FIG. 2L. The masks are then removed, as shown in FIG. 2M. Dielectric cladding layers 108 and 110 are deposited on the first and second sides of the integrated circuit using, for example, sputtering or another suitable deposition technique, as shown in FIG. 2N. Metal layers 112 and 114 are formed over the cladding layer on the first and second sides of the structure, respectively, as shown in FIG. 20. Sputtering or another suitable deposition technique may be used to apply metal layers 112 and 114. Masks 116 and 118 are then used to define contact regions and the waveguide regions and the exposed metal material is removed by etching or another suitable process, as shown in FIGS. 2P and 2Q. If a cladding layer is not used, the metal can be left on the waveguides to capture and reflect scattered light. In FIG. 2R, masks 116 and 118 are removed. Optical, electrical and optoelectronic devices 120 and 121 are then placed at predetermined locations on the first side of the integrated circuit and wirebonded to metal contacts and connections formed by metal layer 112, as shown in FIGS. 2S through 2T. An insulating material 122 is then used to encapsulate the first side of the integrated circuit, as shown in FIG. 2U. The processes shown in FIGS. 2S through 2U are then repeated for the second side of the integrated optical interconnect circuit, the result of which is shown in FIG. 2V with optical, electrical and optoelectronic devices 124 and 125 electrically coupled to metal contacts and connections and encapsulated by an insulating material 126 covering the second side.

Using the above-described process, active devices and components can be placed on both sides of the integrated optical interconnect circuit. Data and signals may be communicated between devices and components placed on opposite sides of the integrated circuit using optical waveguides and optical interconnects.

As shown in FIGS. 3 through 6, by appropriately locating optical interconnect 22 laterally relative to originating optical waveguide 18 and exiting optical waveguide 32, the optical signal can be made to travel in different directions. For example as shown in FIGS. 3 through 6, optical signals proceed in the opposite direction, same direction, to the right, and to the left, relative to the direction of the optical signal in the originating waveguide. It may be seen that originating optical waveguide 18 overlaps at least a portion of optical interconnect 22, and exiting optical waveguide 32 also overlaps at least a portion of optical interconnect 22. Additionally, because optical interconnect 22 is operable to guide the optical signal in a circular manner, the angular displacement between the originating and exiting optical waveguide may span 360 degrees. It may be seen that in FIG. 3 for example, when originating optical waveguide 18 and exiting optical waveguide 32 overlap the same segment or portion of optical interconnect 22, the light travels in the same direction in both waveguides 18 and 32. It may be seen that originating optical waveguide 18 and exiting optical waveguide 32 may be perpendicular with one another or parallel with one another. Optical interconnect 22 is shown in FIGS. 3 through 6 in a ring or circular configuration, however, other configurations such as elliptical, square, rectangular, etc. are also contemplated herein.

Because semiconductor processing techniques known in the art may be used herein, a brief description of the processes is provided herein. However, suitable techniques later developed may also be used to form the structures of the single-side or double-side integrated optical interconnect circuit. Although embodiments of the present invention have been described in detail, it should be understood that a myriad of mutations, modifications, changes, and alterations can be made therein without departing from the teachings of the present invention, the spirit and scope of the invention being set forth by the appended claims.

1. A method of fabricating an integrated optical interconnection between components, comprising:
forming a first optical waveguide in a semiconductor substrate;
forming a first layer of dielectric material disposed above the optical waveguide;
forming an optical interconnect in the first dielectric layer and disposed proximate to the first optical waveguide;
forming a second layer of dielectric material disposed above the optical interconnect;
forming a second optical waveguide in the second layer of dielectric material and disposed proximate to the first optical waveguide; and
forming a conductive contact disposed above and proximate the second optical waveguide, the metal contact operable to make electrical connections between the components.

2. The method, as set forth in claim 1, further comprising placing a component on the optical interconnect circuit and electrically coupling the component to the metal contact.

3. The method, as set forth in claim 1, further comprising encapsulating the optical interconnect circuit.

4. The method, as set forth in claim 1, wherein forming a first optical waveguide in a semiconductor substrate comprises implanting an impurity of a predetermined type in the semiconductor substrate.

5. The method, as set forth in claim 1, wherein forming an optical interconnect in the first dielectric layer comprises implanting an impurity of a predetermined type in the first dielectric layer.

6. The method, as set forth in claim 1, wherein the first optical waveguide overlaps the optical interconnect in a first region, the second optical waveguide overlaps the optical interconnect in a second region, and the first and second regions coincide.

7. The method, as set forth in claim 1, wherein the first optical waveguide overlaps the optical interconnect in a first region, the second optical waveguide overlaps the optical interconnect in a second region, and the first and second regions do not coincide.

8. The method, as set forth in claim 1, wherein the first optical waveguide and the second optical waveguide are perpendicular with one another.

9. The method, as set forth in claim 1, wherein the first optical waveguide and the second optical waveguide are parallel with one another.

10. The method, as set forth in claim 1, wherein forming a first optical waveguide in a semiconductor substrate comprises implanting an impurity into predetermined regions of the semiconductor substrate using a patterned mask defining the predetermined regions of the semiconductor substrate.

11. The method, as set forth in claim 1, wherein forming an optical interconnect in the first dielectric layer comprises implanting an impurity into predetermined regions of the first dielectric layer using a patterned mask defining the predetermined regions of the first dielectric layer.

12. The method, as set forth in claim 1, wherein forming a second optical waveguide in the second layer of dielectric material comprises implanting an impurity into predetermined regions of the second dielectric layer using a patterned mask defining the predetermined regions of the second dielectric layer.

13. The method, as set forth in claim 1, further comprising forming additional optical waveguides and optical interconnects disposed above the second optical waveguide.

14. The method, as set forth in claim 1, further comprising forming a second conductive contact disposed below and proximate the first optical waveguide, the second conductive contact operable to make electrical connections between the components.

15. The method, as set forth in claim 1, further comprising:
securing a first circuit component on the metal contact and forming an electrical connection between the first circuit component with the metal contact; and
securing at least one second circuit component on the second metal contact and forming electrical connection between the at least one second circuit component with the second metal contact.

16. A method of making an optical integrated circuit, comprising:
forming a first dopant region operable to function as an optical waveguide in a substrate;
forming a first layer of dielectric material disposed above the first dopant region;
forming a second dopant region in the first dielectric layer and disposed above and proximate to the first dopant region, the second dopant region operable to optically couple to the first dopant region;
forming a second layer of dielectric material disposed above the second dopant region; and
forming a third dopant region in the second layer of dielectric material and disposed above and proximate to the second dopant region, the third dopant region operable to optically couple to the second dopant region.

17. The method, as set forth in claim 16, forming a conductive contact disposed above and proximate the third dopant region, the conductive contact operable to make electrical connections to a component placed thereon.

18. The method, as set forth in claim 16, wherein forming the third dopant region comprises forming a third dopant region generally perpendicular with the first dopant region.

19. The method, as set forth in claim 16, wherein forming the third dopant region comprises forming a third dopant region generally parallel with the first dopant region.

20. The method, as set forth in claim 16, wherein forming the first, second and third dopant regions comprises using patterned masks defining outlines of the dopant regions for implantation.

21. The method, as set forth in claim 17, wherein the first dopant region is formed in a semiconductor substrate disposed above a semiconductor layer, and the method further comprising:
removing the semiconductor layer disposed below the semiconductor substrate; and
forming a second conductive contact disposed below and proximate the first dopant region, the second conductive contact operable to make electrical connections with a second component placed thereon.

22. The method, as set forth in claim 21, further comprising:
securing a first circuit component on the conductive contact and forming an electrical connection between the first circuit component with the conductive contact; and
securing at least a second circuit component on the second conductive contact and forming electrical connection between the second circuit component with the second conductive contact.

23. An optical integrated circuit, comprising:
a first optical waveguide formed in a first dielectric layer operable to conduct optical signals;
an optical interconnect formed in a second dielectric layer disposed above the first dielectric layer; and
a second optical waveguide formed in a third dielectric layer disposed above the second dielectric layer and operable to conduct optical signals, whereby the optical interconnect is operable to conduct optical signals from the first optical waveguide to the second optical waveguide.

24. The optical integrated circuit, as set forth in claim 23, wherein the optical interconnect has a disk configuration.

25. The optical integrated circuit, as set forth in claim 23, wherein the optical interconnect has a ring configuration.

26. The optical integrated circuit, as set forth in claim 23, wherein the first optical waveguide and the second optical waveguide are oriented at a predetermined angle with one another.

27. The optical integrated circuit, as set forth in claim 23, wherein the first optical waveguide and the second optical waveguide are generally parallel with one another.

28. The optical integrated circuit, as set forth in claim 23, wherein the first optical waveguide and the second optical waveguide are generally perpendicular to one another.

29. The optical integrated circuit, as set forth in claim 23, wherein the first optical waveguide comprises a dopant region formed in the first dielectric layer.

30. The optical integrated circuit, as set forth in claim 23, wherein the second optical waveguide comprises a dopant region formed in the third dielectric layer.

31. The optical integrated circuit, as set forth in claim 23, wherein the optical interconnect comprises a dopant region formed in the second dielectric layer.

32. The optical integrated circuit, as set forth in claim 23, further comprising a conductive contact disposed above the second optical waveguide, the conductive contact operable to make optoelectronic contact with the second optical waveguide.

33. The optical integrated circuit, as set forth in claim 23, further comprising a second conductive contact disposed below the first optical waveguide, the conductive contact operable to make optoelectronic contact with the first optical waveguide.

34. The optical integrated circuit, as set forth in claim 33, further comprising:
a first circuit component disposed above the second optical waveguide and electrically coupled to the conductive contact; and
a second circuit component disposed below the second optical waveguide and electrically coupled to the second conductive contact.

35. A method of making an optical integrated circuit, comprising:
forming a sacrificial layer above a substrate;
forming a first dielectric layer above the sacrificial layer;
forming a first dopant region operable to function as an optical waveguide in the first dielectric layer;
forming a second dielectric layer disposed above the first dielectric layer;
forming a second dopant region in the second dielectric layer and disposed above and proximate to the first dopant region, the second dopant region having a circular outline and operable to optically couple to the first dopant region;
forming a third dielectric layer disposed above the second dielectric layer;
forming a third dopant region in the third dielectric layer and disposed above and proximate to the second dopant region, the third dopant region operable to optically couple to the second dopant region;
removing the sacrificial layer;
forming a first conductive contact above the third dielectric layer; and
forming a second conductive contact below the first dielectric layer.

36. The method, as set forth in claim 35, further comprising:
securing a first circuit component on the first conductive contact and forming an electrical connection between the first circuit component with the first conductive contact; and
securing a second circuit component on the second conductive contact and forming electrical connection between the second circuit component with the second conductive contact.
